(19) United States
(12) Patent Application Publication
(10) Pub. No.: US 2014/0129460 A1
(43) Pub. Date: May 8, 2014

(54) SOCIAL NETWORK FOR EMPLOYMENT SEARCH

(71) Applicants: Joe Budzienski, Newton, MA (US); Venkat Naidu Janapareddy, Woburn, MA (US)

(72) Inventors: Joe Budzienski, Newton, MA (US); Venkat Naidu Janapareddy, Woburn, MA (US)

(21) Appl. No.: 13/667,409

(22) Filed: Nov. 2, 2012

(51) Int. Cl. G06Q 50/00

(52) U.S. Cl. CPC G06Q 50/01; G06Q 10/1053
USPC 705/321

(57) ABSTRACT

Systems and methods described herein provide an application through which social media can accelerate communication between a job seeker and a talent seeker (e.g., an employer).

### BACKGROUND

There are various manners in which job seekers and employers can connect. For example, an employer can post information about a job and receive a resume from the job seeker in response to the posting. A resume can be a document used to present an individual's background and skillsets. A resume often contains a summary of relevant job experience and education and can be provided to the potential employer as a hard copy (e.g., a paper copy) or in an electronic form (e.g., a document sent via e-mail).

### SUMMARY

In one aspect of the present disclosure, a method performed by one or more processing devices includes filtering, by a computer system, job posts that are maintained in a social networking platform based on one or more user-identified characteristics to identify a subset of the job posts that are associated with the one or more identified characteristics, associating a user-selectable control with at least some of the job posts in the identified subset, sending data to a user device to cause the user device to display at least some of the identified subset of the job posts and the associated selectable controls, receiving, at the computer system from the user device, an indication of interest in a particular one of the job posts based on selection of the selectable control associated with the particular one of the job posts by the user device, and generating, by the computer system, a post in the social networking platform of an employer associated with the particular job post for which the indication of interest was received, the post including pre-defined response text and a link to a resume of a user associated with the user device.

Embodiments can include one or more of the following.

The method can also include receiving from the employer at the computer system a request to view a resume of a user associated with the post in the social networking platform of the employer and enabling access to the employer to view the resume of the user.

The method can also include receiving from the user the response text and an automatic-reply text, receiving from the user a resume, and storing the resume, the response text and the automatic-reply text in a memory associated with the computer system.

The method can also include calculating a match score for the job posts in the identified subset based on a similarity between a user profile associated with the user and information associated with the job post, selecting one or more of the job posts in the identified subset based on the calculated match scores, and automatically generating, by the computer system, a post in the social networking platform of an employer associated with the selected one or more job posts, the post including the automatic-reply text and a link to the resume of the user.

The method can also include calculating a match score for the job posts in the identified subset based on a similarity between a user profile associated with the user and information associated with the job post and sorting the job posts in the identified subset based on the calculated match scores. Sending the data to the user device to cause the user device to display at least some of the identified subset of the job posts can include sending data to the user device to cause the user device to display the job posts in the identified subset in an order determined based on the sorting.

The method can also include identifying a trending job post from among the job posts in the identified subset based on a number of individuals who have responded to the job post and wherein sending data to the user device to cause the user device to display the at least some of the identified subset of the job posts can include sending data to the user device to cause the user device to display at least the trending job post ordered in the display with the trending post presented first and additional posts ordered chronologically.

The method can also include identifying a sponsored job post from among the job posts in the identified subset based on a payment received from an employer associated with the job post. Sending data to the user device to cause the user device to display the at least some of the identified subset of the job posts can include sending data to the user device to cause the user device to display at least the sponsored job post ordered in the display with the trending post presented first and additional posts ordered chronologically.

The one or more user-identified characteristics comprises a keyword or hashtag.

All or part of the foregoing can be implemented as a computer program product including instructions that are stored on one or more non-transitory machine-readable storage media, and that are executable on one or more processing devices. All or part of the foregoing can be implemented as an apparatus, method, or electronic system that can include one or more processing devices and memory to store executable instructions to implement the stated functions.

The details of one or more implementations are set forth in the accompanying drawings and the description below. Other features will be apparent from the description and drawings, and from the claims.

### BRIEF DESCRIPTION OF THE DRAWINGS

FIG. 1 illustrates exemplary graphical user interfaces for displaying and responding to a job posting using a social network.

FIG. 2 is a flow chart of an exemplary process for connecting a job seeker with a potential employer.

FIG. 3 illustrates an example of a graphical user interface for providing text used to respond to a job posting.

FIG. 4 illustrates an example of a graphical user interface for displaying a filtered set of job postings.

FIG. 5 illustrates an example of a graphical user interface for displaying a social media feed of an employer.

FIG. 6 illustrates an example of a graphical user interface for displaying job postings.

FIG. 7 illustrates an example of a graphical user interface for displaying job postings.

FIG. 8 is a flow chart of an exemplary process for presenting job postings.

FIG. 9 is a flow chart of an exemplary process for generating automatic responses to job postings.

FIG. 10 illustrates an example of a graphical user interface for providing text used to respond to a job posting.

FIG. 11 is an example of a system.

### DETAILED DESCRIPTION

A system consistent with this disclosure provides an application through which social media can accelerate communication between a job seeker and a talent seeker (e.g., an employer). One manner in which employers seek applicants is by posting information about a job opening or position in a social network. Posting the job opening in the social network can allow the information about the position to be viewed by a large and diverse set of individuals who might not otherwise be informed about the opening. Often a job seeker's feed in the social network can become overwhelmed with updates and job postings, especially if the user is following or connected to a large number of entities. As a consequence, job postings of interest to the job seeker may be missed. Additionally, viewing information about each of the potential job postings and completing the appropriate application process can be time consuming (e.g., an employer may direct an applicant to apply via their online website or to send a resume to a particular address). This multi-step application process may have a negative impact on both the job seeker and the employer. The job seeker may miss out on job postings that potentially may be of interest. The employers may not receive the resumes from all potential respondents. To help encourage connections between the job seeker and the employer, such job-related postings may be extracted from the social networking platform, aggregated, filtered and presented to the user in a user-friendly interface. The systems and methods described herein also assist a job seeker to quickly respond to such job postings in the social network by automatically posting a response to the job posting in the social media of the employer for jobs which the job seeker has expressed interest. In each automatically generated message, a link back to the job seeker's online portfolio (“resume”) is provided. Employers view the postings in their feed in the social media network and if interested, review the job seekers profile and resume.

There are many different examples of electronic social networking platforms. FACEBOOK, TWITTER, LINKEDIN, GOOGLE+, MYSPACE, and ORKUT are just a few examples. But, there are many others, and it is reasonable to expect many more to be launched in the future. The techniques described herein for handling data available from an electronic social networking platform are widely applicable and may be applied to data available from any relevant electronic social networking platform.

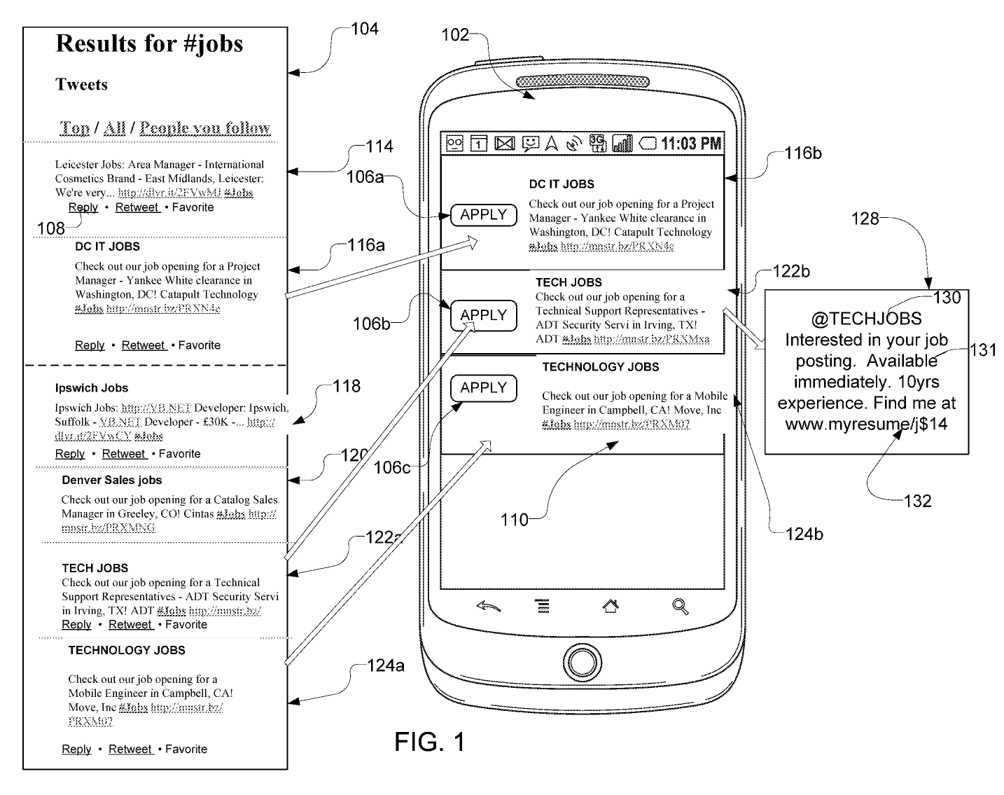

FIG. 1 illustrates aggregation, display, and responses to posts from an electronic social networking platform. The left hand side shows an exemplary post feed 104 for a social network. In this example, the posts 114, 116a, 118, 120, 122a, and 124a included in the feed are selected based on criteria related to the posts. For example, the feed can include posts based on inclusion of a particular symbol (such as a hashtag used by Twitter) before a keyword in the post. In this particular example, a “#jobs” hashtag is used to generate the listing of posts. Thus, the feed includes any messages/posts that include the identified keyword or phrase. The items presented in post feed 104 on the social networking page provide mechanisms that enable the particular user to interact with the items presented in the post feed. For example, each of the posts presented in post feed includes a selectable “Reply” control, for example, the reply control 108. The selectable “Reply” control in a post enables the user to enter a responsive comment to the object(s) included in the post. The electronic social networking platform posts such responsive comments to a social media feed of the poster. These responses can be public (e.g., viewable by other users) or private (e.g., viewable by only the originator of the post). Selection of the reply control 108 generates a blank entry form in which a user can input (e.g., by typing) a response to be posted to the social media feed of the originator.

As noted above, a feed in a social network can become overwhelmed with updates, especially if the user is following or connected to a large number of entities or if posts related to a particular topic are provided with regularity. For example, hundreds of jobs may be posted to a feed in a social network related to job openings every minute. These jobs may range from an opening for a chef at a local restaurant, to an opening for a landscaper, to an opening for a computer programmer. Thus, only a subset of job postings in a social network are likely to be relevant to a particular job seeker.

The systems and methods described herein filter the posts in the social media network to generate a filtered subset of posts that meet certain criteria (as shown in user interface 102). As described in more detail below, the posts from the social media network can be filtered based on interest (e.g., particular job categories), location, required skills, or keyword. In the particular example of FIG. 1, a general job posting feed from the social network (shown as feed 104) is filtered based on job type to provide a filtered listing of jobs related to computer programming and information technology to generate a filtered feed 102 that includes posts 116b, 122b, 124b which correspond to posts 116a, 122a, 124a in feed 104.

Each of the posts in the filtered listing 102 includes a selectable control. For example, each of the posts presented in post feed includes a selectable “apply” control 106a, 106b, and 106c. The selectable “apply” control in a post enables the particular user to automatically provide a response to the post in the social media feed of the posting entity associated with the post based on an indication of their interest in the job posting, such as the user selecting the selectable control. The text of the response, it is automatically accessed by the job posting system and used as the text for a post to the employer social media feed in response to selection of the apply control (e.g., the user does not need to type or otherwise input the text for the reply at the time of responding to a particular job posting). Automatically generating the response text is believed to shorten the time required to respond to a job posting in the social media feed because the user is not required to generate/input the text at the time of submitting the response. Further, automatically inputting the previously stored response text can provide the benefit of decreasing the likelihood that typographical errors such as errors in the URL to a job seekers resume will occur. The posts generated in the employer's feed can be public (e.g., viewable by other users) or private (e.g., viewable by only the originator of the post). For example, selection of the apply control 106b associated with post 116b in feed 102 generates a post 128 in the social media network of the entity which provided the job posting. More particularly, in this example, an entity called “TECH JOBS” provided the initial job posting 122a, which was displayed in the feed 102 as post-122b. Upon user selection of the selectable control 106b a responsive post 128 is generated, directed to the social media feed of “TECH JOBS” (as indicated by the @TECHJOBS address 130). The post 128 includes the address 130, pre-defined text 131 and a link 132 to a resume for the responding job seeker. Thus, by selecting a single selectable control on the user interface, a post including information about the job seeker and a link to his or her resume is automatically provided to the social media feed of the employer. The employer can view further information about job seekers who have responded to the job posting by selecting the link to the resume for the job seeker.

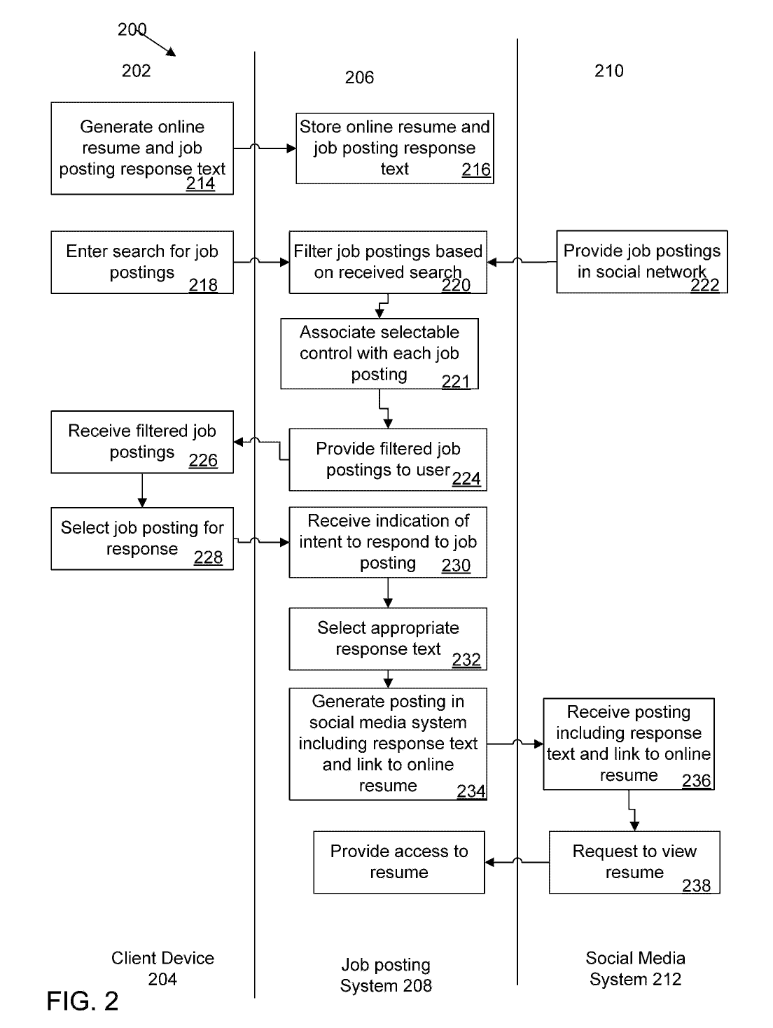

Referring now to FIG. 2, and exemplary process for connecting a job seeker with a potential employer is shown. In FIG. 2, process 200 is split into parts 202, 206, 210. Part 202 may be performed by a client device 204, such as a computer, mobile telephone, tablet computing device, or other computing device associated with a job seeker. Part 206 may be performed by job posting system 208. Part 210 may be performed by social media system 212.

In operation, a job seeker generates and maintains an online portfolio (“resume”) that contains the job seekers information, education, work history, skills, keywords, images, video and/or social media usernames (214). The job seekers online portfolio includes short text statements which succinctly announce the job seeker's personal marketing message. The text statements can be character limited statements suitable for posting to a social media platform (e.g., character text statements of 150 characters or less). These statements intended to be pushed (tweets via Twitter, Status via Facebook) to a social media platform in response to user initiation as described in more detail herein. The job posting system 208 stores the received online resume and job posting response text (216).

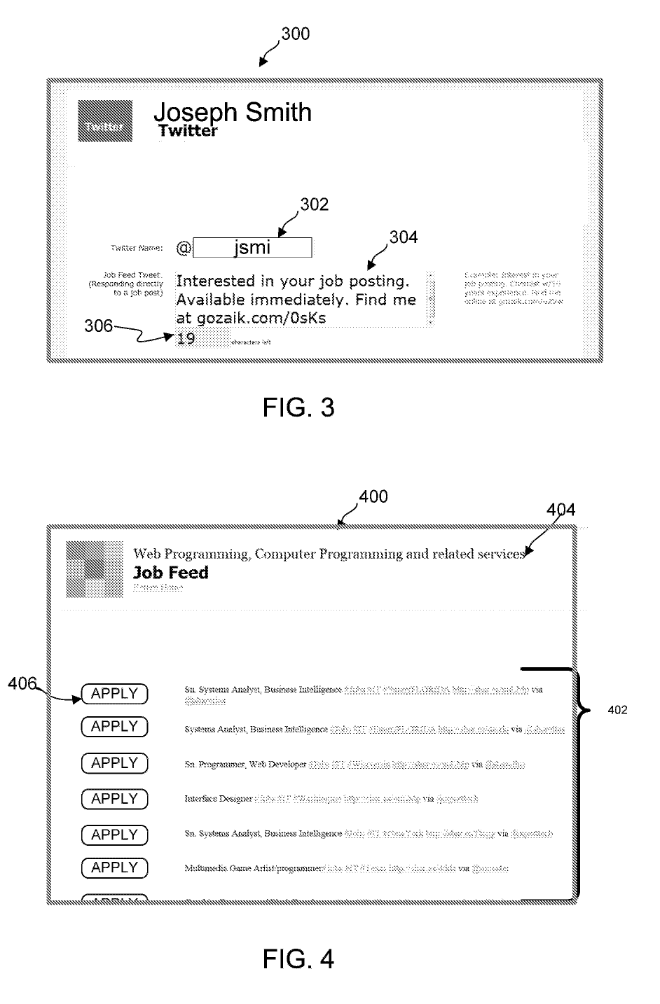

FIG. 3 shows an exemplary user interface 300 for providing a response text suitable for posting to a social media platform. In this example, a user named Joseph Smith provides their social media login name in user entry box 302. User interface 300 also includes a user entry box 304 in which the user can provide text that will form the response to a job posting. Because the social media outlet may limit the length of posts, a number of characters remaining is displayed on the user interface 300 as a characters left indicator 306. While the number of characters available may vary by social media platform, in general, it is believed that limiting the length of the post can be beneficial in aiding the employer to quickly can and review posts by potential job applicants.

Referring again to FIG. 2, after providing and storing an online resume and job posting response text, a job seeker associated with client device 204 enters a search for job postings (218). The job posting system 208 filters job postings from one or more social media platforms based on the received search (220). In order to generate a filtered listing of job related postings, the job posting system 208 receives from a social media system 212 a feed that includes job postings (222). For example, the job posting system 208 may aggregate multiple different social media feeds based on keywords likely to be associated with job postings. In a particular example, if the social media platform includes hash tags, or other indicators of content, the job posting system 208 may subscribe to feeds associated with relevant indicators (e.g., #Jobs, #IPjobs, #ITJobs). The job posting system 208 associates selectable controls with each post in the filtered list of postings (221), and provides the filtered list of job postings to the client device 204 (224). The client device 204 receives the filtered list of job postings (226).

The filtered list of job postings includes the text from the original post in the social media system and a selectable control by which the job seeker can respond to the post. FIG. 4 shows an exemplary user interface 400 that includes a filtered listing of posts 402. The filtered listing of job posts includes posts related to a category or search performed by the user as indicated by category information 404. Additionally, each post in the filtered listing of job posts 402 is associated with a selectable control 406. Selection of selectable control 406 by the user causes the response text associated with the user (e.g., entered in block 304 of user interface 300) to be posted in the social media feed of the employer who originally sent the job posting.

Referring again to FIG. 2, after receiving the filtered list of job postings (226), the user associated with client device 204 can select a job posting for response (228) by selecting the selectable control associated with the post. Upon selection by the user, the job posting system 208 receives an indication of the user's intent to respond to the job posting (230). Based on this received indication, job posting system selects the appropriate response text (232) and generates a posting in the social media system that includes the response text and a link to the online resume of the user associated with client device 204 (234).

Upon generation of the post by job posting system 208, the social media system 212 receives the posting that includes the response text and a link to the users online resume (236). In order to connect with a particular user who has responded to the job posting, a reviewer at the social media system 212 can request to view one or more of the resumes by selection of the link in the social media feed (238) and the job posting system 208 can provide access to the stored resume (240).

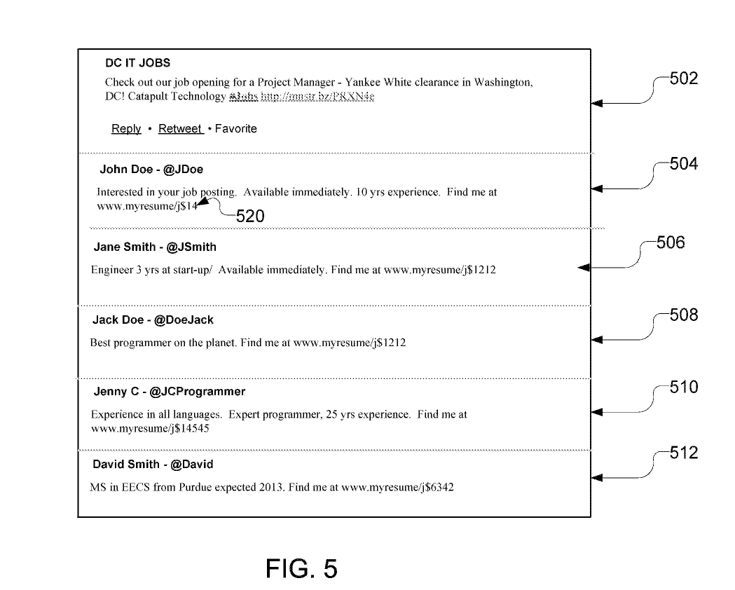

FIG. 5 shows an exemplary user interface 500 of the employer's social media feed. The employer social media feed includes an entry/post 502 that includes the job posting. It is this post that is originally received by the job posting system, provided to the client device 204, and for which responses in the form of posts to the employer's social media feed can be received. The following posts in the employer social media feed include responses (e.g., posts 504, 506, 508, 510, 512) received based on the original job posting 502. These posts include the username of the user associated with the client device 204 responsible for the post, the response text, and a link (e.g., link 520) to the resume for the user associated with client device 204. Thus, an employer can quickly scan a set of potential applicants based on their response text and view resumes of interest by selection of the link to the job seekers resume.

In some embodiments, in addition to providing a filtered listing of job postings based on post in a social media platform, the system can provide one or more sponsored job postings. For example, the job posting system can enable an employer to have one or more of their job postings displayed prior to the reverse chronological listing of job postings based on receipt of a payment from the employer to the job posting system.

FIG. 6 shows an exemplary user interface 600 for displaying job postings from one or more social networking platforms. User interface 600 is divided into two sections, a sponsored jobs section 602 and a reverse chronologically ordered job postings section 604. The sponsored job section 602 includes one or more job postings from the social networking platform that are promoted to the top of the job feed based on a received payment from the employer. For example, in a job feed displayed to a job seeker, a predetermined number of sponsored job postings can be displayed prior to the listing of job postings such as the listing shown in FIG. 4. The sponsored jobs included in the sponsored jobs section 602 can be selected based on a match between keywords in the search submitted by the job seeker and/or selected based on a category or field of jobs being viewed by the job seeker. In one particular example, the job posting system can provide multiple job type categories and the employer can select which of these categories to promote their job posting as a sponsored job. For the category selected by the employer, the job posting will be displayed in the sponsored jobs section 602 for job seekers searching/viewing job postings associated with the job type, category.

In some embodiments, in addition to providing a filtered listing of job postings based on posts in a social media platform, the system can provide one or more trending job postings. For example, the job posting system can track the number of individuals responding to various job postings, and generate a set of job postings that are popular. It is believed that providing a set of trending job postings can be beneficial to a job seeker as it can quickly identify to the job seeker a subset of jobs for which there is general excitement or interest amongst other job seekers.

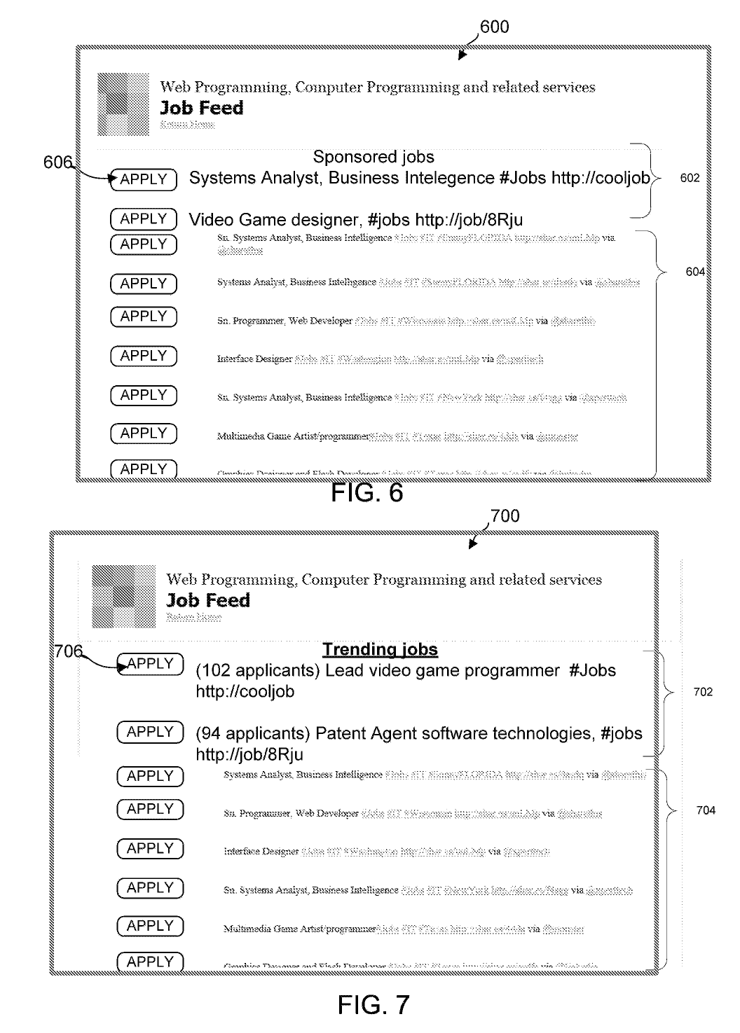

FIG. 7 shows an exemplary user interface 700 for displaying a job postings from one or more social networking platforms. User interface 700 is divided into two sections, a trending job section 702 and a chronologically ordered job postings section 704. The trending job sections includes one or more job postings from the social networking platform that are promoted to the top of the displayed job feed based on a number of individuals who have responded to the job posting. For example, in a job feed displayed to a job seeker, a predetermined number of trending job postings can be displayed prior to the listing of job postings such as the listing shown in FIG. 4. The trending jobs included in the trending jobs section 702 can be selected based on a match between keywords in the search submitted by the job seeker and/or selected based on a esponse level calculated for the job posting. In one particular example, the job posting system can select the job postings to display in the trending jobs section 702 based on a time weighted average. For example, a score can be calculated based on the number of times the job posting has been displayed to job seekers, the number of job seekers who have responded to the job posting, and/or a time since the job posting was first presented. In one particular example, the score can be calculated based on the percentage of individuals viewing the job posting who have responded to the job posting.

In another particular example, the score can be calculated based on a number of individuals who have responded to the job posting divided by a length of time that the job posting has been active in the system (e.g., a number of hours). The job postings included in the trending jobs section 702 can then be selected based on the calculated score. For example, by selecting a predetermined number of job postings having the highest scores.

In another example (not shown in the figures), a set of less popular job postings can be provided to a user. For example, a user with a less than stellar resume or job experience may have difficulty competing for a job posting for which many other job seekers have responded. Such an individual may desire to respond to job postings for which there is less competition. In order to identify job postings with a low number of respondents, the job posting system can sort job postings based on a score calculated from the number of job seekers who have responded to the job posting. For example, the job postings displayed in the job seekers job feed, can be sorted and displayed in an order that is based on the popularity of the job posting with job postings having a lower number of respondents displayed prior to job postings having a higher number of respondents. It is believed that displaying job postings with a low number of respondents can be beneficial to both the job seeker and the employer as it can identify to the job seeker job openings for which there is less competition and it can be beneficial to the employer because it can encourage jobseekers to apply for the job opening.

In some additional examples, it can be beneficial to display the job postings included in an individual's job feed and in order that is based on a perceived relevance to the job seeker rather than presenting the job postings and a reverse chronological order. For example, a score can be calculated based on similarity between a jobseeker's user profile and a job posting. This score can be used to sort the job postings and display the job postings and in order that is based on the similarity between the jobseeker's user profile and the job posting.

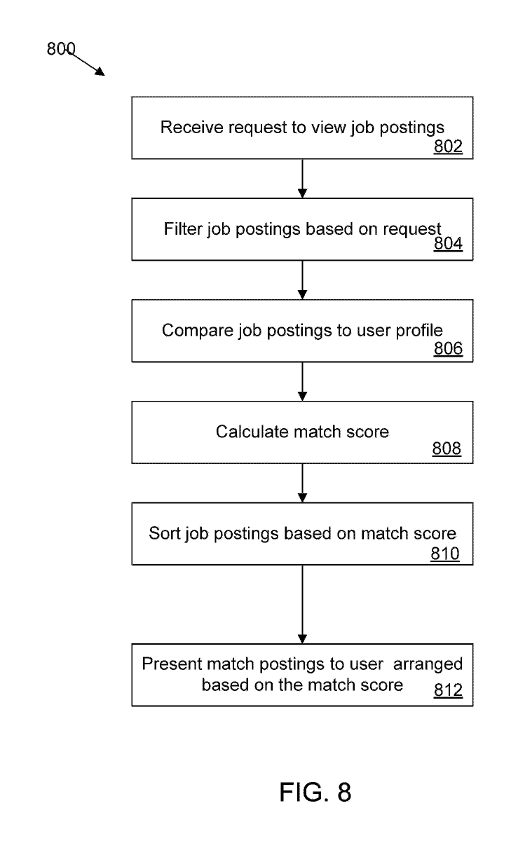

FIG. 8 shows a flowchart of a process 800 for displaying job postings and in order that is determined based at least in part on a calculated match score. The job posting system receives a request to view job postings from a job seeker (802). The job posting system filters job postings from one or more social media platforms based on the received request (804). Filtering the job postings from the one or more social media platforms generates a subset of job postings that are believed to be potentially relevant to the job seeker. Additionally, the job postings can be filtered based on a timestamp of the posting to remove postings that have been active in the system for a period of time exceeding a threshold. For the job postings in this identified subset, the job posting system compares the job posting to a user profile for the job seeker (806). Based on the comparison, the job posting system calculates a match score (808). The match score is indicative of similarity between the job posting and the user profile of the job seeker. After calculating match scores for the subset of identified job postings, the job posting system sorts the job postings in the identified subset based on the calculated match scores (810). The job posting system presents the client device the job seeker a filtered set of job postings that are arranged in an order that is based at least in part on the calculated match score. In one particular example, the order can be based on the match score such that job postings are displayed in order of descending match scores. In another example, the order can be based on both the match score and a length of time the job posting has been active in the system.

In some embodiments, in addition to enabling the job seeker to easily respond to job postings, the job posting system can additionally provide automatic responses to job postings for the job seeker. For example, the job posting system can select a subset of job postings which appear to be relevant for the job seeker and automatically respond to the job posting for the job seeker. It is believed that, in some situations, automatically responding to job postings for a job seeker can be beneficial to both the job seeker and the employer. For example, automatically responding to job postings having a high degree of relevance to the job seeker can assist the job seeker in having their resume viewed by potential employers. Additionally, automatically responding to job postings can be beneficial to the employer because the employer may view additional resumes of individuals who otherwise may not have responded to the job posting. Responses that have been automatically generated by the job posting system can include an indicia indicative of the automatic nature of the response in the post added to the employer's social media feed. Thus, when reviewing responses in the social media feed, the employer can determine which responses were actively submitted by the job seeker and which were provided automatically.

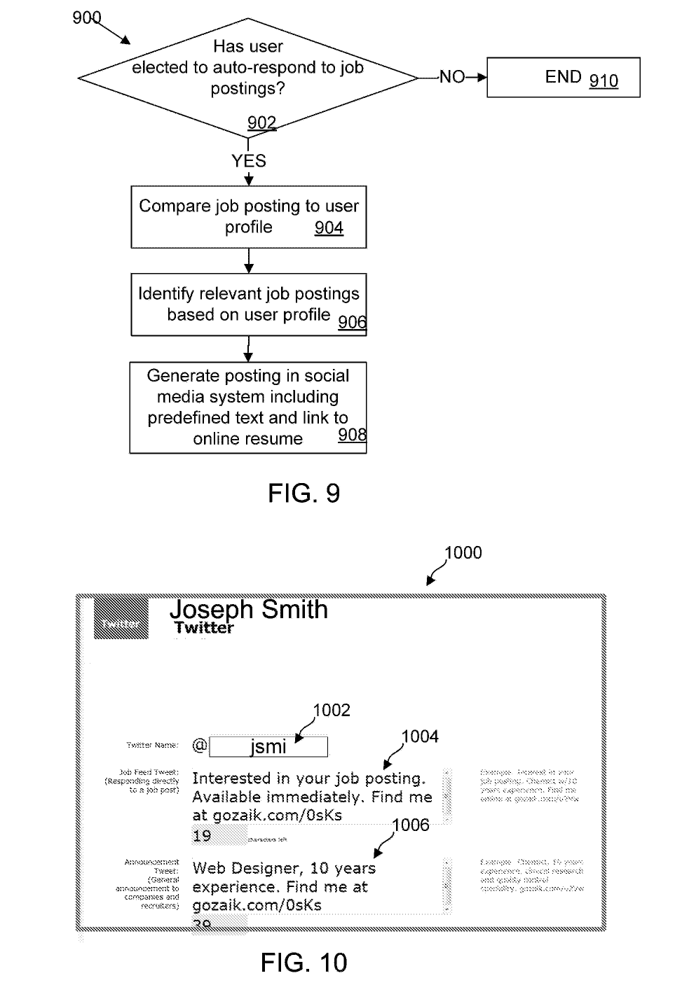

FIG. 9 shows a flowchart of a process 900 for automatically generating posts in a social media platform of an employer. The job posting system determines whether a particular user has elected to auto respond to job postings (902). If the user has not elected to auto respond to job postings, the automated response process ends (910). On the other hand, if the user has elected to auto respond to job postings, the job posting system compares received job postings to the user's profile (904). Based on the comparison of the job posting to the user profile, the job posting system identifies relevant job postings (906). For example, the system can compare the calculated score to a threshold to select job postings having match scores exceeding the threshold. In another example, the job posting system can sort job postings to identify a predetermined number of job postings for which an automatic response should be generated by identifying the job postings having the highest scores. After identifying relevant job postings, the job posting system generates a post in the social media platform of the employer for job postings identified based on the comparison of the job posting to the users profile (908). The posting in the social media feed of the employer includes predefined text provided by the job seeker and a link to the job seeker's online resume. In some examples, the post in the social media feed of the employer can additionally include an indicia indicative of the automatic nature of the response.

FIG. 10 shows an exemplary user interface 1000 for providing a response text suitable for posting to the social media platform. In this example, a user named Joseph Smith provides their social media login name in user entry box 1002. User interface 1000 also includes a user entry box 1004 in which the user can provide text that will form the response to a job posting for which the job seeker has actively responded to the job posting (e.g., by clicking the apply button as shown in FIG. 1 above). User interface 1000 also includes a user entry box 1006 which the user can provide text that will form the response to a job posting for which the job posting system has automatically responded to the job posting on behalf of the job seeker. Separate entries and texts are provided such that the job seeker can have different text provided based on whether they have actively or automatically responded to the job posting.

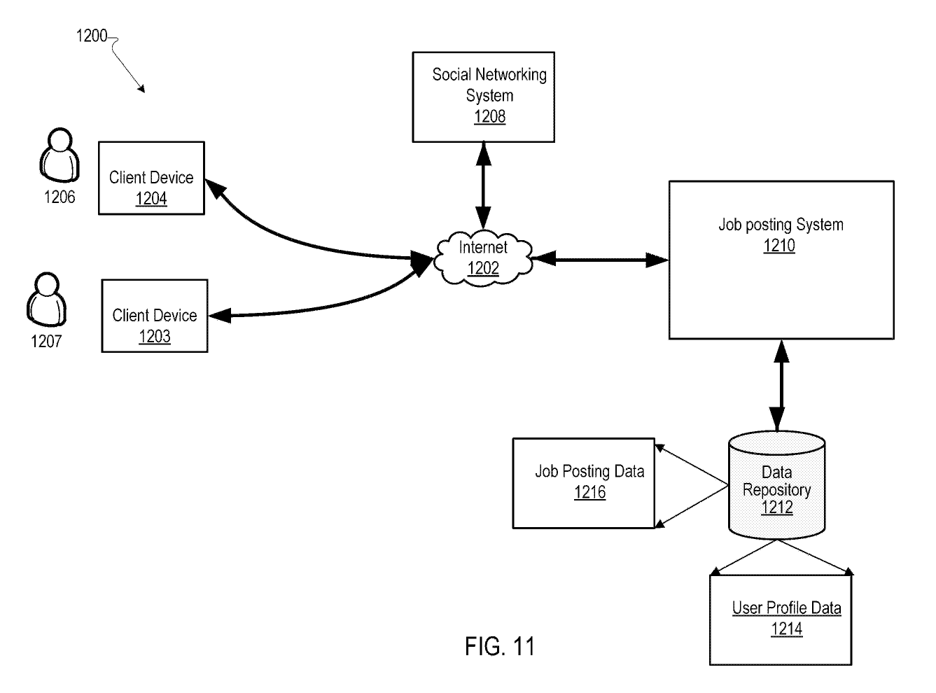

FIG. 11 is a block diagram of an example of a network environment 1200 enabling responses to a job posting to be provided to an employer's social media feed. Network environment 1200 includes network 1202, a client devices 1204 and 1203, job posting system 1210, and social networking system 1208. Network environment 1200 may include many thousands of data repositories, client devices, and social networking systems, which are not shown.

In an example, client device 1204 is associated with user 1206 and client device 1203 is associated with user 1207. In this example, user 1206 or 1207 may be a job seeker. Client devices 1204 and 1203 can be any computing device with access to the Internet such as a mobile telephone, a tablet computing device, a laptop computer, or a desktop computer.

In the example of FIG. 12, job posting system 1210 includes a system that hosts applications, including, e.g., an application for connecting employers and job seekers. In an example, client devices 1204, 1203 may download a client application for interacting with job posting system 1210. In another example, client devices 1204, 1203 may use a web browser to access the job posting system 1210, e.g., rather than downloading a client application for interacting with the job posting system 1210. In an example, an application provided by the job posting system may be configured to render one or more of graphical user interfaces described herein. In an example, job posting system stores, in data repository 1212, information 1216 about job postings included in feeds from one or more social networking systems 1208 and user profile data 1214 including a user's online resume and response text.

In an example, users 1206, 1207 of job posting system access the job posting application by logging into the application from client devices 1204, 1203, respectively. Once logged in, users 1204, 1203 can view and respond to job postings provided in a job posting feed (e.g., as described herein). In this example, job posting system uses the social media account of the user to respond by posting a post in the social networking system of the employer from the account of the user. As such, users 1206, 1207 may have to be logged into the job posting system using a login of a social networking platform in order to review and respond to job postings in their job feed.

In the example of FIG. 12, social networking system 1208 is configured to implement social networking platform. Typically, a social networking platform includes an electronic resource (e.g., a web site) that enables users of the social networking platform to connect with other users and to receive updates from the other users in the form of electronic messages (e.g., posts). There are many different examples of social networking platforms. FACEBOOK, TWITTER, LINKEDIN, GOOGLE+, MYSPACE, and ORKUT are just a few examples. But, there are many others, and it is reasonable to expect many more to be launched in the future. The techniques described herein for handling data available within a social networking platform are widely applicable and may be applied to data available within any relevant social networking platform.

Social networking platforms frequently enable individual users (e.g., users who have registered with a platform and/or who have been assigned a unique or otherwise identifying identifier by the platform) to establish connections with other user identities. These connections between users may reflect relationships between the underlying human users who correspond to the user identities. For example, a connection between two users within a social networking platform may reflect a social friendship (e.g., developed through physical interaction in the real-world and/or through on-line interaction in the cyber-world) or a professional relationship between the underlying human users who correspond to the user identities. In some social networking platforms, a user may be able to unilaterally form a connection with another user. For example, a social networking platform may enable a first user to form a connection to a second user simply by specifying a desire to form a connection to the second user and without requiring approval of the connection by the second user. Alternatively, in other social networking platforms, the formation of connections between two users may be a bilateral process. For example, in such social networking platforms, when a first user specifies a desire to form a connection to a second user, the social networking platform may establish the connection only after the second user approves the formation of the connection between the first user and the second user.

In an example, job posting system 1210 is configured to retrieve, from social networking system 1208, a feed that includes job postings submitted by employers on the social networking system.

Job posting system 1210 can be a variety of computing devices capable of receiving data and running one or more services, which can be accessed by one or more of client devices 1204, 1203. In an example, job posting system 1210 can include a server, a distributed computing system, a desktop computer, a laptop, a cell phone, a rack-mounted server, and the like. Job posting system 1210 can be a single server or a group of servers that are at a same position or at different positions. Job posting system 1210 and each of client devices 1204, 1203, and social networking system 1208 can run programs having a client-server relationship to each other. Although distinct modules are shown in the figures, in some examples, client and server programs can run on the same device.

Job posting system 1210 can receive data from each of client devices 1204, 1203 and social networking system 1212 through an input/output (I/O) interface. I/O interface can be a type of interface capable of receiving data over a network, including, e.g., an Ethernet interface, a wireless networking interface, a fiber-optic networking interface, a modem, and so forth. Job posting system 1210 also includes a processing device and memory. A bus system, including, for example, a data bus and a motherboard, can be used to establish and to control data communication between the components of the job posting system 1210.

A processing device of the Job posting system 1210 can include one or more microprocessors. Generally, the processing device can include an appropriate processor and/or logic that is capable of receiving and storing data, and of communicating over a network (not shown). The memory can include a hard drive and a random access memory storage device, including, e.g., a dynamic random access memory, or other types of non-transitory machine-readable storage devices. The memory associated with job posting system 1210 stores computer programs that are executable by a processing device. These computer programs may include a data engine (not shown) for implementing the operations and/or the techniques described herein. The data engine can be implemented in software running on a computer device (e.g., application system 1222), hardware or a combination of software and hardware.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible program carrier for execution by, or to control the operation of, a processing device. Alternatively or in addition, the program instructions can be encoded on a propagated signal that is an artificially generated signal, e.g., a machine-generated electrical, optical, or electromagnetic signal that is generated to encode data for transmission to suitable receiver apparatus for execution by a processing device. The machine-readable medium can be a machine-readable storage device, a machine-readable storage substrate, a random or serial access memory device, or a combination of one or more of them.

The term “processing device” encompasses all kinds of apparatus, devices, and machines for processing data, including by way of example a programmable processor, a computer, or multiple processors or computers. The processing device can include special purpose logic circuitry, e.g., an FPGA (field programmable gate array) or an ASIC (application-specific integrated circuit). The processing device can also include, in addition to hardware, code that creates an execution environment for the computer program in question, e.g., code that constitutes processor firmware, a protocol stack, a database management system, an operating system, or a combination of one or more of them.

A computer program (which may also be referred to as a program, software, a software application, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer may be a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer implemented method comprising:
filtering, by a computer system, job posts that are maintained in a social networking platform based on one or more user-identified characteristics to identify a subset of the job posts that are associated with the one or more identified characteristics;
associating a user-selectable control with at least some of the job posts in the identified subset;
sending data to a user device to cause the user device to display at least some of the identified subset of the job posts and the associated selectable controls;
receiving, at the computer system from the user device, an indication of interest in a particular one of the job posts based on selection of the selectable control associated with the particular one of the job posts by the user device; and
generating, by the computer system, a post in the social networking platform of an employer associated with the particular job post for which the indication of interest was received, the post including pre-defined response text and a link to a resume of a user associated with the user device.

2. The method of claim 1, further comprising:
receiving from the employer at the computer system a request to view a resume of a user associated with the post in the social networking platform of the employer; and
enabling access to the employer to view the resume of the user.

3. The method of claim 1, further comprising:
receiving from the user the response text and an automatic-reply text;
receiving from the user a resume; and
storing the resume, the response text and the automatic-reply text in a memory associated with the computer system.

4. The method of claim 3, further comprising:
calculating a match score for the job posts in the identified subset based on a similarity between a user profile associated with the user and information associated with the job post;
selecting one or more of the job posts in the identified subset based on the calculated match scores; and
automatically generating, by the computer system, a post in the social networking platform of an employer associated with the selected one or more job posts, the post including the automatic-reply text and a link to the resume of the user.

5. The method of claim 1, further comprising:
calculating a match score for the job posts in the identified subset based on a similarity between a user profile associated with the user and information associated with the job post; and
sorting the job posts in the identified subset based on the calculated match scores;
wherein sending the data to the user device to cause the user device to display at least some of the identified subset of the job posts comprises sending data to the user device to cause the user device to display the job posts in the identified subset in an order determined based on the sorting.

6. The method of claim 1, further comprising
identifying a trending job post from among the job posts in the identified subset based on a number of individuals who have responded to the job post; and
wherein sending data to the user device to cause the user device to display the at least some of the identified subset of the job posts comprises sending data to the user device to cause the user device to display at least the trending job post ordered in the display with the trending post presented first and additional posts ordered chronologically.

7. The method of claim 1, further comprising
identifying a sponsored job post from among the job posts in the identified subset based on a payment received from an employer associated with the job post; and
wherein sending data to the user device to cause the user device to display the at least some of the identified subset of the job posts comprises sending data to the user device to cause the user device to display at least the sponsored job post ordered in the display with the trending post presented first and additional posts ordered chronologically.

8. The method of claim 1, wherein the one or more user-identified characteristics comprises a keyword or hashtag.

9. A computer program product tangibly embodied on a computer readable medium,
the computer program product comprising instructions to cause a processor to:
filter job posts that are maintained in a social networking platform based on one or more user-identified characteristics to identify a subset of the job posts that are associated with the one or more identified characteristics;
associate a user-selectable control with at least some of the job posts in the identified subset;
send data to a user device to cause the user device to display at least some of the identified subset of the job posts and the associated selectable controls;
receive an indication of interest in a particular one of the job posts based on selection of the selectable control associated with the particular one of the job posts by the user device; and
generate a post in the social networking platform of an employer associated with the particular job post for which the indication of interest was received, the post including pre-defined response text and a link to a resume of a user associated with the user device.

10. The computer program product of claim 9, further comprising instructions to:
receive from the employer a request to view a resume of a user associated with the post in the social networking platform of the employer; and
enable access to the employer to view the resume of the user.

11. The computer program product of claim 9, further comprising instructions to:
receive from the user the response text and an automatic-reply text;
receive from the user a resume; and
store the resume, the response text and the automatic-reply text in a memory associated with the computer system.

12. The computer program product of claim 11, further comprising instructions to:
calculate a match score for the job posts in the identified subset based on a similarity between a user profile associated with the user and information associated with the job post;
select one or more of the job posts in the identified subset based on the calculated match scores; and
automatically generate a post in the social networking platform of an employer associated with the selected one or more job posts, the post including the automatic-reply text and a link to the resume of the user.

13. The computer program product of claim 9, further comprising instructions to:
calculate a match score for the job posts in the identified subset based on a similarity between a user profile associated with the user and information associated with the job post; and
sort the job posts in the identified subset based on the calculated match scores;
wherein the instructions to send the data to the user device to cause the user device to display at least some of the identified subset of the job posts comprises instructions to send data to the user device to cause the user device to display the job posts in the identified subset in an order determined based on the sorting.

14. The computer program product of claim 9, further comprising instructions to:
identify a trending job post from among the job posts in the identified subset based on a number of individuals who have responded to the job post; and
wherein the instructions to send data to the user device to cause the user device to display the at least some of the identified subset of the job posts comprise instructions to send data to the user device to cause the user device to display at least the trending job post ordered in the display with the trending post presented first and additional posts ordered chronologically.

15. The computer program product of claim 9, further comprising instructions to:
identify a sponsored job post from among the job posts in the identified subset based on a payment received from an employer associated with the job post; and
wherein the instructions to send data to the user device to cause the user device to display the at least some of the identified subset of the job posts comprises instructions to send data to the user device to cause the user device to display at least the sponsored job post ordered in the display with the trending post presented first and additional posts ordered chronologically.

16. The computer program product of claim 9, wherein the one or more user-identified characteristics comprises a keyword or hashtag.

17. An electronic system comprising:
one or more processing devices; and
one or more machine-readable media configured to store instructions that are executable by the one or more processing devices to perform operations comprising:
filter job posts that are maintained in a social networking platform based on one or more user-identified characteristics to identify a subset of the job posts that are associated with the one or more identified characteristics;
associate a user-selectable control with at least some of the job posts in the identified subset;
send data to a user device to cause the user device to display at least some of the identified subset of the job posts and the associated selectable controls;
receive an indication of interest in a particular one of the job posts based on selection of the selectable control associated with the particular one of the job posts by the user device; and
generate a post in the social networking platform of an employer associated with the particular job post for which the indication of interest was received, the post including pre-defined response text and a link to a resume of a user associated with the user device.

18. The electronic system of claim 17, further comprising instructions to:
receive from the employer a request to view a resume of a user associated with the post in the social networking platform of the employer; and
enable access to the employer to view the resume of the user.

19. The electronic system of claim 17, further comprising instructions to:
receive from the user the response text and an automatic-reply text;
receive from the user a resume; and
store the resume, the response text and the automatic-reply text in a memory associated with the computer system.

20. The electronic system of claim 17, further comprising instructions to:
calculate a match score for the job posts in the identified subset based on a similarity between a user profile associated with the user and information associated with the job post;
select one or more of the job posts in the identified subset based on the calculated match scores; and
automatically generate a post in the social networking platform of an employer associated with the selected one or more job posts, the post including the automatic-reply text and a link to the resume of the user.

21. The electronic system of claim 17, further comprising instructions to:
calculate a match score for the job posts in the identified subset based on a similarity between a user profile associated with the user and information associated with the job post; and
sort the job posts in the identified subset based on the calculated match scores;
wherein the instructions to send the data to the user device to cause the user device to display at least some of the identified subset of the job posts comprises instructions to send data to the user device to cause the user device to display the job posts in the identified subset in an order determined based on the sorting.

22. The electronic system of claim 17, further comprising instructions to:
identify a trending job post from among the job posts in the identified subset based on a number of individuals who have responded to the job post; and
wherein the instructions to send data to the user device to cause the user device to display the at least some of the identified subset of the job posts comprise instructions to send data to the user device to cause the user device to display at least the trending job post ordered in the display with the trending post presented first and additional posts ordered chronologically.

23. The electronic system of claim 17, further comprising instructions to:
identify a sponsored job post from among the job posts in the identified subset based on a payment received from an employer associated with the job post; and
wherein the instructions to send data to the user device to cause the user device to display the at least some of the identified subset of the job posts comprises instructions to send data to the user device to cause the user device to display at least the sponsored job post ordered in the display with the trending post presented first and additional posts ordered chronologically.

24. The electronic system of claim 17, wherein the one or more user-identified characteristics comprises a keyword or hashtag.
